(19) United States
(12) Patent Application Publication
(10) Pub. No.: US 2007/0254521 A1
(43) Pub. Date: Nov. 1, 2007

(54) Insulation displacement terminal

(76) Inventors: Roberto D'Agostini, Venezia (IT); Fiorenzo Bisello, Padova (IT); Gianni Zuin, Padova (IT)

Correspondence Address: MOLEX INCORPORATED, 2222 WELLINGTON COURT, LISLE, IL, 60532, US

(21) Appl. No.: 11/414,475

(22) Filed: Apr. 28, 2006

(51) Int. Cl. H01R 4/24

(52) U.S. Cl. 439/404

(57) ABSTRACT

A one-piece terminal structure includes a mounting section for connection to an appropriate circuit trace on a circuit board. A terminating section is provided for connection to an electrical wire and includes at least three generally parallel slotted walls. The walls have aligned slots with mouths for receiving the electrical wire. A center one of the walls has an insulation displacement slot for cutting through outer insulation of the wire and engaging an inner conductor of the wire. A pair of outside ones of the three walls on opposite sides of the center wall have strain relief slots for clamping onto the outer insulation of the wire.

### FIELD OF THE INVENTION

This invention generally relates to the art of electrical connectors and, particularly, to an insulation displacement terminal for connecting an electrical wire to a printed circuit board.

### BACKGROUND OF THE INVENTION

Generally, electrical connectors include some form of dielectric housing mounting a plurality of conductive terminals for making electrical connection between a pair of electrical devices. For instance, one electrical connector may mate with another complementary electrical connector with the respective terminals thereof interengaging. Other electrical connectors may interconnect a conductor of an electrical wire to a circuit trace on a printed circuit board.

One type of electrical connector commonly is called an insulation displacement connector which is equipped with insulation displacement terminals (IDT) for termination of insulated electrical wires. IDT connectors do not require the stripping of insulation from a section of an insulated conductor prior to the insertion of the conductor into the connector. In essence, elongated insulated electrical wires are terminated within connector housings by forcing portions of the terminals through the outer insulation of the wires and into engagement with the central conductors of the wires. Such connectors normally require some strain relief for the wires after termination with the terminals to prevent unintentional withdrawal of the wires from the terminals. For instance, flexible arms or wings are provided on the connector housing to prevent the electrical wire from backing out of its terminated position.

Insulation displacement terminals have been used as “bare connectors” for terminating the insulated electrical wires. The terminal is considered “bare” because it does not have a dielectric housing surrounding it. Furthermore, these bare terminals only cut through the wire insulation to electrically engage the wire conductor and have no portion just clamping the insulation to provide strain relief as the housing provided previously. The present invention is directed to solving these problems by providing an insulation displacement terminal which incorporates a self-contained system for providing strain relief for the terminated wire.

### SUMMARY OF THE INVENTION

An object, therefore, of the invention is to provide a new and improved insulation displacement terminal for connecting an insulated electrical wire to a printed circuit board, the electrical wire including an inner conductor surrounded by an outer insulation.

In the exemplary embodiment of the invention, a one-piece terminal structure includes a mounting section for connection to an appropriate circuit trace on a circuit board. A terminating section is provided for connection to the electrical wire and includes at least three generally parallel slotted walls. The walls have aligned slots with mouths for receiving the electrical wire. A center one of the walls has an insulation displacement slot for cutting through the insulation of the wire and engaging the inner conductor of the wire. A pair of outside ones of the three walls on opposite sides of the center wall have strain relief slots for clamping onto the outer insulation of the wire.

Preferably, the one-piece terminal structure is stamped and formed of conductive sheet metal material. The mounting section may be generally flat for surface connection to the circuit trace on the circuit board. Alternatively, the mounting section may include one or more pin portions for insertion into appropriate holes in the circuit board and for connection to the circuit trace on the board and/or in the holes. The mounting section also may include a mounting post for insertion into a mounting hole in the circuit board to position the terminal on the board.

According to one embodiment of the invention, one of the slotted outside walls has opposite edges. The center slotted wall is folded from one edge to overlie the one outside wall. The other outside wall is folded from the other edge to overlie the center wall, resulting in three generally parallel walls formed from the one-piece terminal structure.

According to another embodiment of the invention, the terminating section is generally box-shaped to define a first pair of opposite walls and a second pair of opposite walls. The first pair of opposite walls have the strain relief slots therein. The center wall with the insulation displacement slot is formed out of at least one of the second pair of opposite walls and is disposed between the first pair of opposite walls. In the preferred embodiment, a pair of wall portions are formed out of the second pair of opposite walls to define the center slotted wall. The wall portions project inwardly between the first pair of opposite walls and form the insulation displacement slot therebetween. In the second embodiment, the mounting section also is generally box-shaped as a continuation of the box-shaped terminating section.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the FIGS. and in which:

FIG. 1 is a perspective view of an insulation displacement terminal according to a first embodiment of the invention;

FIG. 2 is a top plan view of the first embodiment;

FIG. 3 is a side elevational view of the first embodiment;

FIG. 4 is an end elevational view, looking at the right-hand end of FIG. 1;

FIG. 5 is a perspective view of the terminal of FIG. 1, mounted on a printed circuit board and terminating an insulated electrical wire;

FIG. 6 is a perspective view looking at a different angle in FIG. 5;

FIG. 7 is a perspective view of an insulation displacement terminal according to a second embodiment of the invention, terminated to an insulated electrical wire;

FIG. 8 is a perspective view of the second embodiment, looking at the bottom of FIG. 7;

FIG. 9 is a perspective view of the second embodiment, mounted on a printed circuit board;

FIG. 10 is a schematic illustration of the dimensional relationship between the slots in the slotted walls of either embodiment; and

FIGS. 11-13 are sequential views showing the process of terminating an insulated electrical wire into the insulation displacement terminal of FIGS. 1-5.

### DETAILED DESCRIPTION OF THE PREFERRED EMBODIMENTS

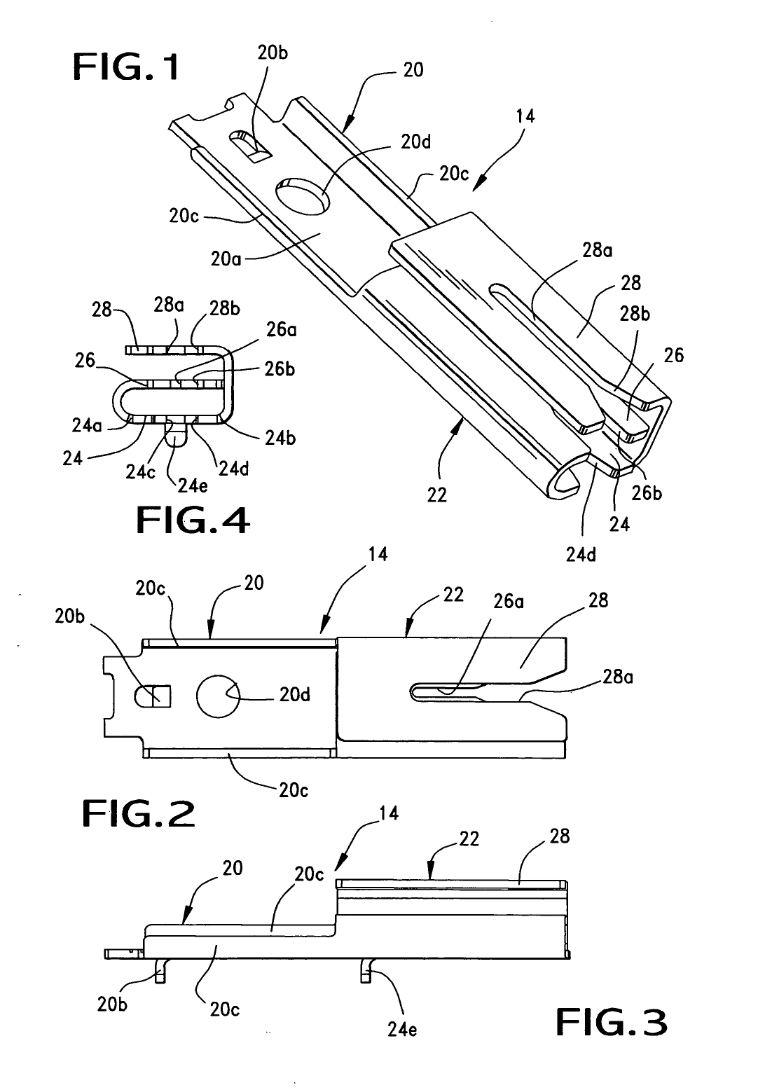

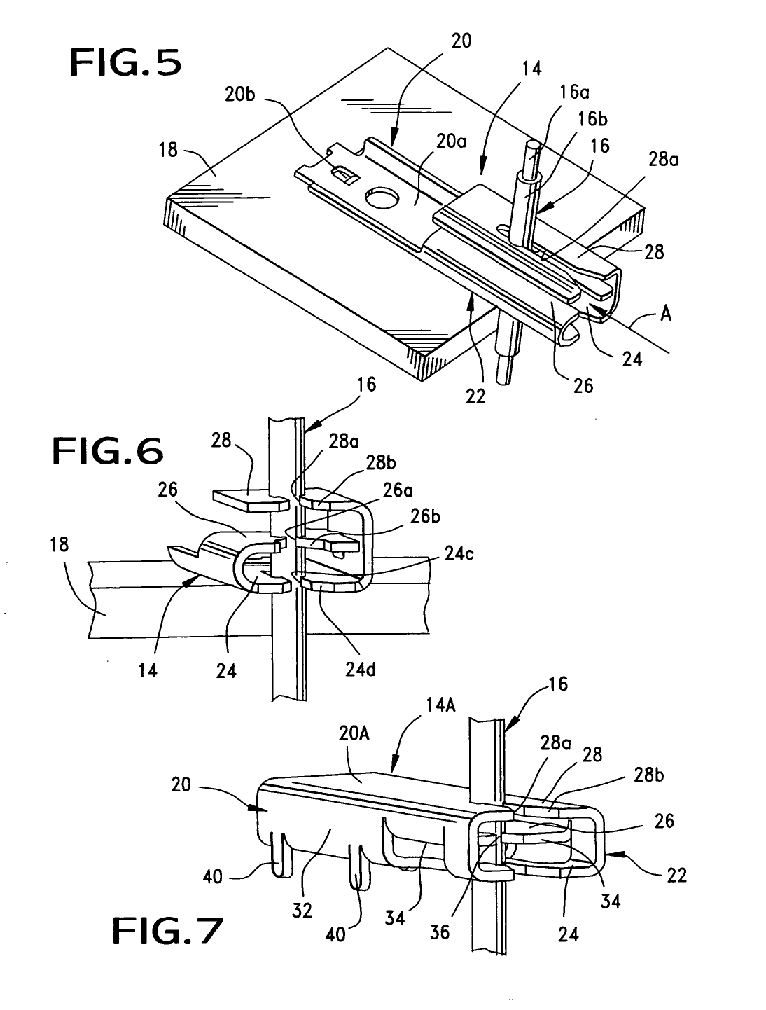

Referring to the drawings in greater detail, and first to FIGS. 1-4, an insulation displacement terminal, generally designated 14, is shown according to a first embodiment of the invention. The terminal is designed for connecting an insulated electrical wire, generally designated 16 (FIGS. 5 and 6), to a printed circuit board 18. The insulated electrical wire is of a typical construction in that it includes an inner conductor 16a surrounded by an outer insulation 16b.

More particularly, the insulation displacement terminal 14 is a one-piece terminal structure and may be stamped and formed of conductive sheet metal material. The terminal is elongated and includes a mounting section, generally designated 20, at one end thereof and a terminating section, generally designated 22, at an opposite end thereof. Mounting section 20 basically is formed by a flat wall 20a for surface connection, as by soldering, to an appropriate circuit trace on printed circuit board 18 as can be seen best in FIG. 5. A mounting post 20b may be stamped and formed out of the flat wall for insertion into an appropriate mounting hole in the circuit board to properly position the terminal on the board. The opposite side edges 20c of flat wall 20a are turned-up to provide stiffening or reinforcing ribs along opposite edges of the flat wall. A hole 20d is stamped in the flat wall 20a and simply is provided to index the terminal through a forming die or process.

Terminating section 22 of the one-piece terminal 14 includes three generally parallel slotted walls 24, 26 and 28. Wall 24 is a continuation of flat wall 20a of mounting section 20. Wall 24 has opposite edges 24a and 24b as shown in FIG. 4. It can be seen in FIG. 4 that wall 26 is folded inwardly from edge 24a to overlie wall 24. Wall 28 is folded from the opposite edge 24b to overlie wall 26. Therefore, wall 26 is a center, insulation displacement wall, as described below, while walls 24 and 28 are outside, strain relief walls.

More particularly, center wall 26 has an insulation displacement slot 26a (FIGS. 2 and 4) which is of a width for cutting through the insulation 16b of electrical wire 16 and engaging the inner conductor 16a of the wire. The insulation displacement slot has an outwardly flared mouth 26b for guiding the wire into the slot. The strain relief walls 24 and 28 both have strain relief slots 24c and 28a, respectively, for clamping onto the outer insulation 16b of electrical wire 16. The strain relief slots are wider than the insulation displacement slot 26a of center wall 26. Strain relief slots 24c and 28a have outwardly flared mouths 24d and 28b, respectively, for guiding the electrical wire into the slots. Finally, as seen in FIG. 3, the strain relief wall 24 may be stamped and formed with a mounting post 24e (similar to mounting post 20b) for insertion into an appropriate mounting hole in the printed circuit board, again to properly position the terminal on the board.

FIGS. 5 and 6 show electrical wire 16 having been forced in the direction of arrow “A” (FIG. 5) into the insulation displacement slot 26a in center wall 26 and into the strain relief slots 24c and 28a in the outside walls 24 and 28, respectively. When the wire is forced into the slots, the insulation displacement slot 26a cuts through the insulation 16b of electrical wire 16 and engages the inner conductor 16a of the wire. Simultaneously, the strain relief slots 24c and 28a of the two outside walls 24 and 28, respectively, clamp onto the outer insulation 16b of the electrical wire to provide strain relief for the wire on opposite sides of the insulation displacement wall and, thereby, prevent inadvertent withdrawal or bending of the wire. If the wire is bent, the electrical connection between center wall 26 and the inner conductor of the wire could be damaged.

FIGS. 7-9 show a second embodiment of an insulation displacement terminal, generally designated 14A, for connecting an insulated wire 16 to printed circuit board 18. Again, the terminal is a one-piece structure stamped and formed of conductive sheet metal material and includes a mounting section, generally designated 20, and a terminating section, generally designated 22, at opposite ends of an elongated structure. Therefore, like reference numerals have been applied in FIGS. 7-9 to designate like components described above in relation to the first embodiment as shown in FIGS. 1-6. The description of some of those components will not be repeated in order avoid unnecessary duplicity.

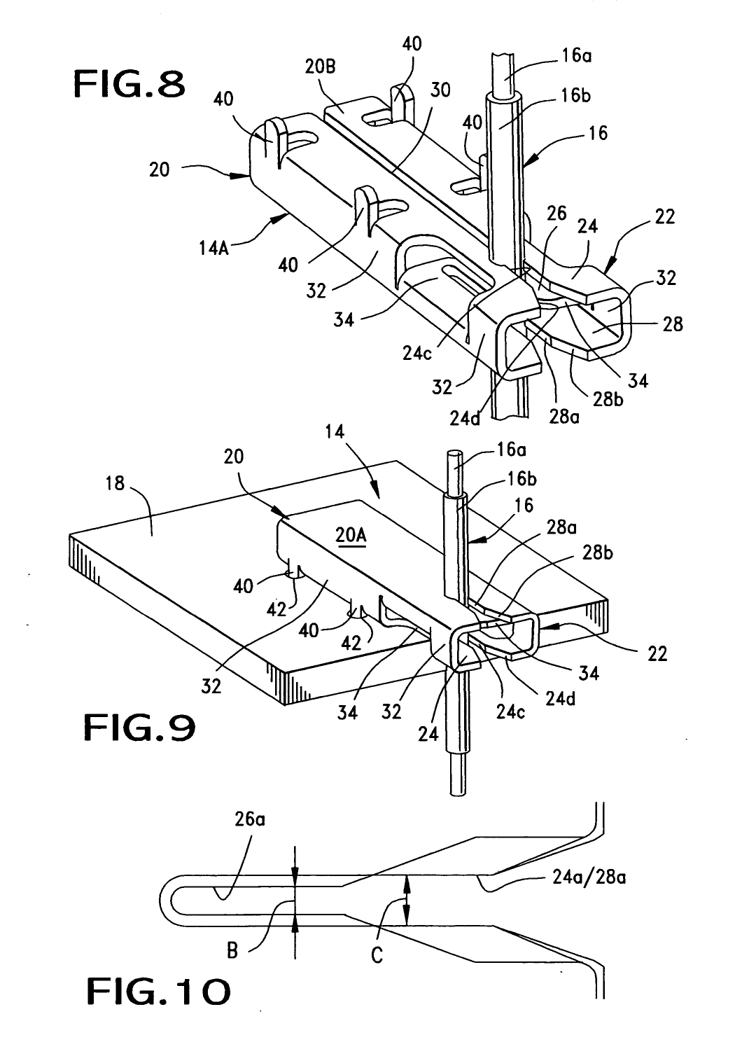

With those understandings, it can be seen in FIGS. 7-9 that terminal 14A is generally box-shaped from one end to the other. Mounting section 20 is box-shaped and has a top wall 20A (FIGS. 7 and 9) and a bottom wall 20B (FIG. 8). Bottom wall 20B corresponds to flat wall 20a of the mounting section of the first embodiment. Being a one-piece structure, the terminal is folded over to define a seam 30 which runs the length of the terminal.

Like the first embodiment, terminating section 22 of terminal 14A of the second embodiment includes three generally parallel slotted walls 24, 26 and 28. Wall 26 is the center insulation displacement wall, while walls 24 and 28 are the strain relief walls at opposite sides of the insulation displacement wall. With the terminating section 22 being box-shaped, the strain relief walls 24 and 28 form opposite walls of the box-shape, while a pair of side walls 32 form the other opposite walls of the box-shape. Center wall 26 is formed by a pair of wall portions 34 which are stamped and formed out of side walls 32 and are bent inwardly to form the insulation displacement wall 26. Wall portions 34 meet at a seam 36 (FIG. 7) which forms the insulation displacement slot of center wall 26. With seam 30 running the length of the terminal, the seam forms the strain relief slot 24c in strain relief wall 24. Strain relief wall 28 is a continuation of top wall 20A of the mounting section 20 and is formed with strain relief slot 28a.

The center, slotted insulation displacement wall 26 and the outside, slotted strain relief walls 24 and 28 of terminal 14A function the same as the corresponding walls in terminal 14 of the first embodiment. However, rather than being a surface connected terminal as in the first embodiment, terminal 14A of the second embodiment includes a plurality of pin portions 40 which are stamped and formed out of bottom wall 20B of mounting section 20. These pin portions act as solder tails for insertion into appropriate holes 42 (FIG. 9) in printed circuit board 18 and for solder connection to appropriate circuit traces on the board and/or in the holes.

FIG. 10 is a schematic illustration of the size or width relationship between the insulation displacement slot 26a in center walls 26 of terminals 14 and 14A versus the size or width of slots 24c/28a in the strain relief walls 24 and 28, respectively. The insulation displacement slot has a width “B” and the strain relief slots have widths “C”. The width of the insulation displacement slot is narrower for cutting through the insulation 16b of electrical wire 16 and engaging the inner conductor 16a of the wire. The wider strain relief slots are dimensioned for clamping onto the outer insulation of the wire without significantly increasing the insertion forces of the wire into the terminal (e.g., if all three slots cut through the insulation).

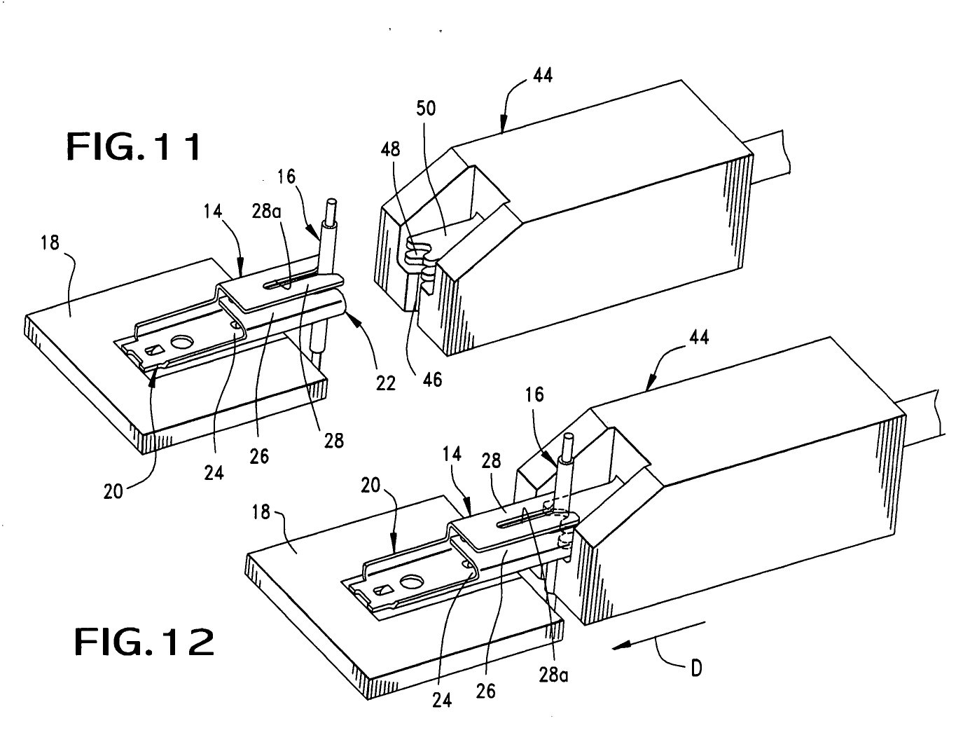

FIGS. 11-13 show an insertion tool, generally designated 44, for inserting electrical wire 16 into terminal 14 of the first embodiment. The tool has an insertion recess 46 and a pair of insertion blades 48 and 50. The insertion recess 46 will engage the wire below the terminal. Insertion blade 48 will engage the wire between walls 24 and 26 of the terminal. Insertion blade 50 will engage the wire between walls 26 and 28 of the terminal. These three engagement points ensure that the wire is inserted uniformly into the three slots of the three walls.

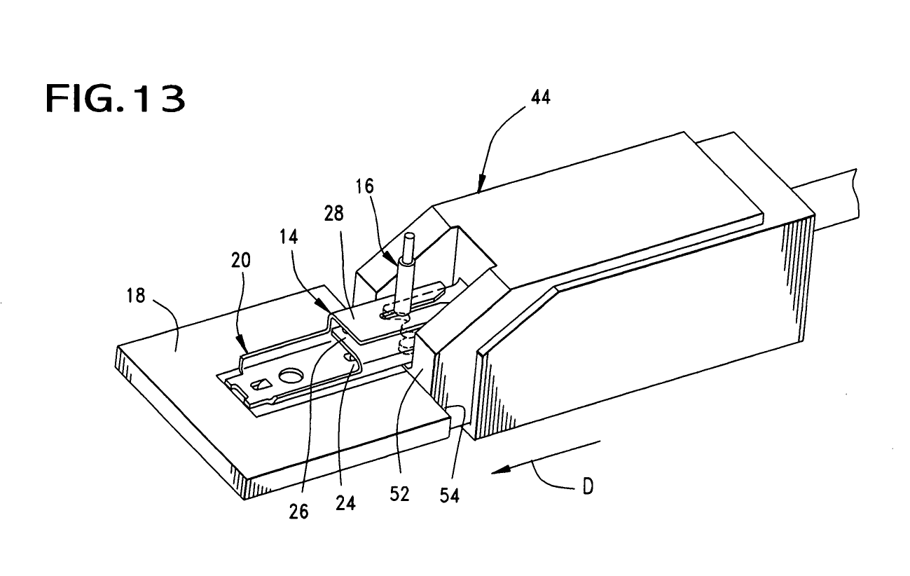

FIG. 11 shows tool 44 removed from the terminal, with electrical wire 16 slightly pressed into the slots of the terminal just enough to temporarily hold the wire aligned with the slots. Tool 44 then is moved in the direction of arrow “D” in FIG. 12 to start forcing the wire into the slots in the terminal. FIG. 13 shows the tool having fully inserted the wire into the terminal. A front face 52 of the tool can abut against an edge 54 of printed circuit board 18 to define the limit position of insertion of the wire so that the wire is not excessively forced against the bottoms of the slots.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. An insulation displacement terminal for connecting an insulated electrical wire to a printed circuit board, the electrical wire including an inner conductor surrounded by an outer insulation, comprising:
a one-piece terminal structure including
a mounting section for connection to an appropriate circuit trace on the circuit board;
a terminating section for connection to the electrical wire and including at least three generally parallel spaced apart slotted walls having aligned slots with mouths for receiving the electrical wire;
a center one of said walls having an insulation displacement slot for cutting through the outer insulation of the wire and engaging the inner conductor of the wire; and
a pair of outside ones of said three walls on opposite sides of the center wall having strain relief slots for clamping onto the outer insulation of the wire.

2. The insulation displacement terminal of claim 1 wherein said one-piece terminal structure is stamped and formed of conductive sheet metal material.

3. The insulation displacement terminal of claim 1 wherein said one-piece terminal structure is elongated with the mounting section at one end thereof and the terminating section at an opposite end thereof.

4. The insulation displacement terminal of claim 1 wherein said mounting section is generally flat for surface connection to the circuit trace on the circuit board.

5. An insulation displacement terminal for connecting an insulated electrical wire to a printed circuit board, the electrical wire including an inner conductor surrounded by an outer insulation, comprising:
a one-piece terminal structure including,
a mounting section for connection to an appropriate circuit trace on the circuit board;
a terminating section for connection to the electrical wire and including at least three generally parallel slotted walls having aligned slots with mouths for receiving the electrical wire;
a center one of said walls having an insulation displacement slot for cutting through the outer insulation of the wire and engaging the inner conductor of the wire;
a pair of outside ones of said three walls on opposite sides of the center wall having strain relief slots for clamping onto the outer insulation of the wire; and
said mounting section includes a pin portion for insertion into an appropriate hole in the circuit board and for connection to the circuit trace on the circuit board.

6. An insulation displacement terminal for connecting an insulated electrical wire to a printed circuit board, the electrical wire including an inner conductor surrounded by an outer insulation, comprising:
a one-piece terminal structure including:
a mounting section for connection to an appropriate circuit trace on the circuit board;
a terminating section for connection to the electrical wire and including at least three generally parallel slotted walls having aligned slots with mouths for receiving the electrical wire;
a center one of said walls having an insulation displacement slot for cutting through the outer insulation of the wire and engaging the inner conductor of the wire;
a pair of outside ones of said three walls on opposite sides of the center wall having strain relief slots for clamping onto the outer insulation of the wire; and
at least one of said mounting section and said terminating section includes a mounting post portion for insertion into an appropriate mounting hole in the circuit board.

7. An insulation displacement terminal for connecting an insulated electrical wire to a printed circuit board, the electrical wire including an inner conductor surrounded by an outer insulation, comprising:
a one-piece terminal structure including;
a mounting section for connection to an appropriate circuit trace on the circuit board;
a terminating section for connection to the electrical wire and including at least three generally parallel slotted walls having aligned slots with mouths for receiving the electrical wire;
a center one of said walls having an insulation displacement slot for cutting through the outer insulation of the wire and engaging the inner conductor of the wire;
a pair of outside ones of said three walls on opposite sides of the center wall having strain relief slots for clamping onto the outer insulation of the wire; and
one of said outside walls has opposite edges, the center wall being folded from one edge to overlie the one outside wall, and the other outside wall being folded from the other edge of the one outside wall to overlie the center wall.

8. The insulation displacement terminal of claim 1 wherein said terminating section is generally box-shaped to define a first pair of opposite walls and a second pair of opposite walls, the first pair of opposite walls having said strain relief slots, and the center wall with the insulation displacement slot being formed out of at least one of said second pair of opposite walls and being disposed between the first pair of opposite walls.

9. The insulation displacement terminal of claim 8 wherein a pair of wall portions are formed out of said second pair of opposite walls to define said center slotted wall, the wall portions projecting inwardly between the first pair of opposite walls and forming said insulation displacement slot therebetween.

10. The insulation displacement terminal of claim 8 wherein said mounting section also is generally box-shaped as a continuation of the box-shaped terminating section.

11. An insulation displacement terminal for connecting an insulated electrical wire to a printed circuit board, the electrical wire including an inner conductor surrounded by an outer insulation, comprising:
an elongated one-piece terminal structure stamped and formed of conductive sheet metal material and including
a mounting section for connection to an appropriate circuit trace on the circuit board; and
a terminating section for connection to the electrical wire and including at least three generally parallel slotted walls having aligned slots with mouths for receiving the electrical wire,
a center one of said walls having an insulation displacement slot for cutting through the outer insulation of the wire and engaging the inner conductor of the wire,
a pair of outside ones of said three walls on opposite sides of the center wall having strain relief slots for clamping onto the outer insulation of the wire, and
wherein one of said outside walls has opposite edges with the center wall being folded from one edge to overlie the one outside wall and with the other outside wall being folded from the other edge of the one outside wall to overlie the center wall.

12. The insulation displacement terminal of claim 11 wherein said mounting section is generally flat for surface connection to the circuit trace on the circuit board.

13. The insulation displacement terminal of claim 11 wherein said mounting section includes a pin portion for insertion into an appropriate hole in the circuit board and for connection to the circuit trace on the circuit board.

14. The insulation displacement terminal of claim 11 wherein at least one of said mounting section and said terminating section includes a mounting post portion for insertion into an appropriate mounting hole in the circuit board.

15. An insulation displacement terminal for connecting an insulated electrical wire to a printed circuit board, the electrical wire including an inner conductor surrounded by an outer insulation, comprising:
an elongated one-piece terminal structure stamped and formed of conductive sheet metal material and including
a mounting section for connection to an appropriate circuit trace on the circuit board;
a terminating section for connection to the electrical wire and including at least three generally parallel spaced apart slotted walls having aligned slots with mouths for receiving the electrical wire;
a center one of said walls having an insulation displacement slot for cutting through the outer insulation of the wire and engaging the inner conductor of the wire;
a pair of outside ones of said three walls on opposite sides of the center wall having strain relief slots for clamping onto the outer insulation of the wire; and
wherein said terminating section is generally box-shaped to define a first pair of opposite walls and a second pair of opposite walls with the first pair of opposite walls having said strain relief slots and with the center wall with the insulation displacement slot being formed out of at least one of said second pair of opposite walls and being disposed between the first pair of opposite walls.

16. The insulation displacement terminal of claim 15 wherein said mounting section is generally flat for surface connection to the circuit trace on the circuit board.

17. An insulation displacement terminal for connecting an insulated electrical wire to a printed circuit board, the electrical wire including an inner conductor surrounded by an outer insulation, comprising:
an elongated one-piece terminal structure stamped and formed of conductive sheet metal material and including:
a mounting section for connection to an appropriate circuit trace on the circuit board;
a terminating section for connection to the electrical wire and including at least three generally parallel slotted walls having aligned slots with mouths for receiving the electrical wire;
a center one of said walls having an insulation displacement slot for cutting through the outer insulation of the wire and engaging the inner conductor of the wire;
a pair of outside ones of said three walls on opposite sides of the center wall having strain relief slots for clamping onto the outer insulation of the wire;
said terminating section is generally box-shaped to define a first pair of opposite walls and a second pair of opposite walls with the first pair of opposite walls having said strain relief slots and with the center wall with the insulation displacement slot being formed out of at least one of said second pair of opposite walls and being disposed between the first pair of opposite walls; and
said mounting section includes a pin portion for insertion into an appropriate hole in the circuit board and for connection to the circuit trace on the circuit board.

18. The insulation displacement terminal of claim 15 wherein a pair of wall portions are formed out of said second pair of opposite walls to define said center slotted wall, the wall portions projecting inwardly between the first pair of opposite walls and forming said insulation displacement slot therebetween.

19. The insulation displacement terminal of claim 15 wherein said mounting section also is generally box-shaped as a continuation of the box-shaped terminating section.

20. An insulation displacement terminal for connecting an insulated electrical wire to a printed circuit board, the electrical wire including an inner conductor surrounded by an outer insulation, comprising:
a one-piece terminal structure including
a mounting section for connection to an appropriate circuit trace on the circuit board;
a terminating section for connection to the electrical wire and including at least three generally parallel slotted walls having aligned slots with mouths for receiving the electrical wire;
a center one of said walls having an insulation displacement slot for cutting through the outer insulation of the wire and engaging the inner conductor of the wire; and
a pair of outside ones of said three walls on opposite sides of the center wall having strain relief slots for clamping onto the outer surface of the insulation of the wire.
